(19) United States
(12) Patent Application Publication
(10) Pub. No.: US 2026/0360996 A1
(43) Pub. Date: Nov. 12, 2026

(54) DOUBLY EMBEDDED ANTENNA ARRAY

(71) Applicant: VIASAT, INC., CARLSBAD, CA (US)

(72) Inventor: Steven J. Franson, Scottsdale, AZ (US)

(21) Appl. No.: 19/100,244

(22) PCT Filed: Aug. 1, 2023
(86) PCT No.: PCT/US2023/029246

§ 371 Date: Jan. 31, 2025

Related U.S. Application Data
(60) Provisional application No. 63/396,116, filed on Aug. 8, 2022.

(51) Int. Cl. H01Q 21/06; H01Q 3/36

(52) U.S. Cl. CPC H01Q 21/065; H01Q 3/36

(57) ABSTRACT

An antenna apparatus includes a plurality of subassemblies each comprising: an antenna substrate having an upper surface and a lower surface, with at least one antenna element formed on the lower surface; at least one semiconductor component forming part of a beamforming network, and having a lower surface attached to the upper surface of the antenna substrate, where the at least one semiconductor component is RF coupled to the at least one antenna element through the antenna substrate; and first molding material formed on the upper surface of the antenna substrate and at least partially encapsulating the at least one semiconductor component.

### TECHNICAL FIELD

This disclosure relates generally to antennas and more particularly to an antenna array with embedded components and methods of forming the same.

### DISCUSSION OF RELATED ART

Antenna arrays are currently deployed in a variety of applications at microwave and millimeter wave frequencies, such as in aircraft, satellites, vehicles, and base stations for general land-based communications. Such antenna arrays typically include microstrip radiating elements driven with phase shifting beamforming circuitry to generate a phased array for beam steering. In many cases it is desirable for an entire antenna system, including the antenna array and beamforming circuitry, to occupy minimal space with a low profile while still meeting requisite performance metrics. To this end, a thin, generally planar structure for an antenna apparatus is desirable. The structure may have a sandwich type configuration including antenna elements upon an antenna substrate, disposed in an exterior facing component layer, and integrated circuits (ICs) distributed across a parallel component layer behind the antenna substrate. The ICs may include monolithic microwave ICs (MMICs) with front end circuitry such as RF power amplifiers (PAS) for transmit operations, low noise amplifiers (LNAs) for receive operations, bandpass filters, and phase shifters for beam steering. It is desirable for the RFICs to be close to the antenna elements for optimum performance. Other ICs of the antenna apparatus, such as field programmable gate arrays (FPGAs), may include circuitry providing biasing and control signals to the MMICs, or baseband/digital signal processing circuitry.

When manufacturing an antenna array, it is often difficult to determine which (if any) antenna elements and/or semiconductor components of the antenna array are not performing up to par or have become defective. Additionally, the antenna substrate may be composed of a low loss but brittle dielectric material such as glass. When the antenna substrate is relatively large, as in the case of an antenna array including a multiplicity of antenna elements to form a narrow beam, the antenna substrate is more susceptible to breakage, particularly when designed to operate over a wide temperature range.

### SUMMARY

In an aspect of the presently disclosed technology, an antenna apparatus includes a plurality of subassemblies each comprising: an antenna substrate having an upper surface and a lower surface, with at least one antenna element formed on the lower surface; at least one semiconductor component forming part of a beamforming network, and having a lower surface attached to the upper surface of the antenna substrate, where the at least one semiconductor component is RF coupled to the at least one antenna element through the antenna substrate; and first molding material formed on the upper surface of the antenna substrate and at least partially encapsulating the at least one semiconductor component. Second molding material adheres adjacent subassemblies to one another. The subassemblies may be cooperatively coupled to form an electronically steerable array such as a phased array.

In another aspect, a method of forming an antenna apparatus includes: forming a plurality of subassemblies, each formed by: providing an antenna substrate having an upper surface and a lower surface; forming a plurality of antenna elements on the lower surface; attaching at least one semiconductor component, to form part of a beamforming network of the antenna apparatus, to the upper surface of the antenna substrate; forming first molding material on the upper surface of the antenna substrate, at least partially encapsulating the at least one semiconductor component. The subassemblies are placed adjacent to one another, but separated by gaps between antenna substrates of adjacent subassemblies. The subassemblies are adhered to one another by applying second molding material therebetween.

### BRIEF DESCRIPTION OF THE DRAWINGS

The above and other aspects and features of the disclosed technology will become more apparent from the following detailed description, taken in conjunction with the accompanying drawings in which like reference numerals indicate like elements or features. Various elements of the same or similar type may be distinguished by annexing the reference label with an underscore/dash and second label that distinguishes among the same/similar elements (e.g., _1, _2), or directly annexing the reference label with a second label. However, if a given description uses only the first reference label, it is applicable to any one of the same/similar elements having the same first reference label irrespective of the second label. Elements and features may not be drawn to scale in the drawings.

FIG. 1A is a plan view of an example subassembly of an antenna apparatus according to an embodiment.

FIG. 1B is an end view of the subassembly of FIG. 1A.

FIG. 2 is an example schematic diagram depicting beamforming components of the subassembly of FIG. 1A and placement of the subassembly within a test fixture.

FIG. 3A is a plan view of an embedded antenna structure including a plurality of the subassemblies of FIG. 1A adhered together.

FIGS. 3B, 3C and 3D are respective end views of the embedded antenna structure of FIG. 3A in the direction 3B, each depicting an example structure.

FIG. 4 is an end view of an antenna apparatus, including the embedded antenna structure of FIG. 3A, according to an embodiment.

FIG. 5 is an example cross-sectional view depicting the embedded antenna structure of FIG. 3A along the path 5-5′, connected to a portion of a printed wiring board of the antenna apparatus.

FIG. 6 is a plan view of an example subassembly of an antenna apparatus according to a digital beamforming embodiment.

FIG. 7A schematically illustrates example receive path circuitry of at least one IC chip in the subassembly of FIG. 6.

FIG. 7B schematically illustrates example transmit path circuitry of at least one IC chip in the subassembly of FIG. 6.

FIG. 8 is a plan view of an embedded antenna structure including a plurality of the subassemblies of FIG. 6 adhered together.

FIG. 9 is a flow diagram of an example method for fabricating an antenna subassembly of an antenna apparatus according to an embodiment.

FIG. 10 is a flow diagram of an example method of fabricating an antenna apparatus including a plurality of antenna subassemblies.

FIGS. 11A, 11B and 11C illustrate example interim structures of an antenna apparatus according to embodiments of methods for forming the antenna apparatus.

### DETAILED DESCRIPTION OF EMBODIMENTS

The following description, with reference to the accompanying drawings, is provided to assist in a comprehensive understanding of certain exemplary embodiments of the technology disclosed herein for illustrative purposes. The description includes various specific details to assist a person of ordinary skill the art with understanding the technology, but these details are to be regarded as merely illustrative. For the purposes of simplicity and clarity, descriptions of well-known functions and constructions may be omitted when their inclusion may obscure appreciation of the technology by a person of ordinary skill in the art.

Herein, the “/” symbol between a first element and a second element means that both the first and second elements are present in one example, but only the first element or only the second element is present in other examples.

In embodiments of antenna apparatus such as those described below, a plurality of antenna subassemblies, each including at least one antenna element and at least one embedded semiconductor component, may be individually formed and RF/electrically tested. Antenna subassemblies that satisfy predetermined performance metrics may then be adhered together using molding material to form an active antenna array assembly with a low profile. In this manner, a composite antenna substrate may be formed with higher reliability, in that breakage due to coefficient of thermal expansion (CTE) mismatch is less likely (particularly in the case of an antenna substrate composed primarily of glass). Additionally, compared to an antenna array assembly formed without interim testing of subassemblies, higher overall performance is attainable. This is due to the ability to select superior performing subassemblies within a manufacturing lot, and to reject defective subassemblies, based on the RF/electrical testing prior to the final assembly.

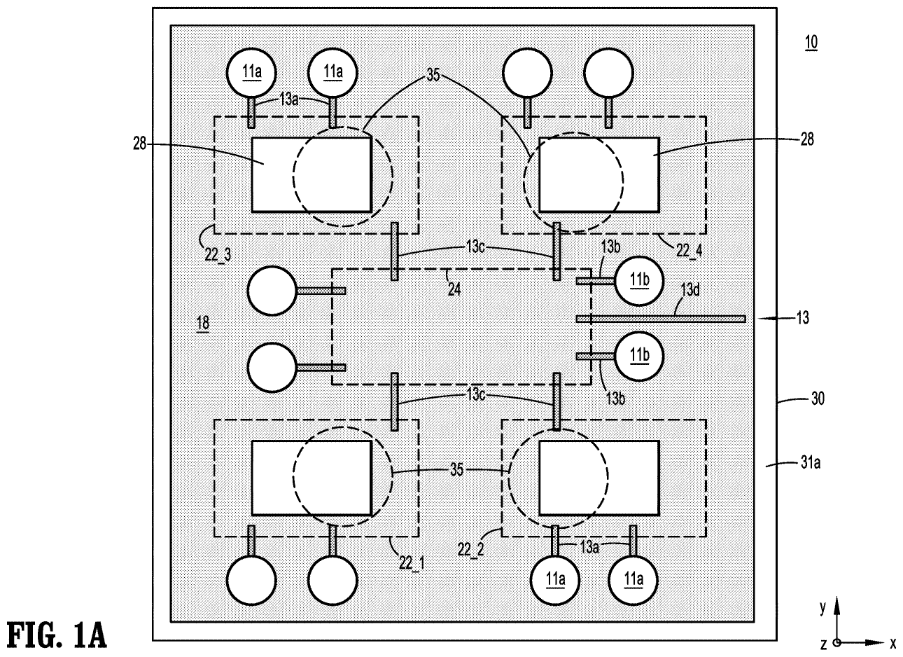

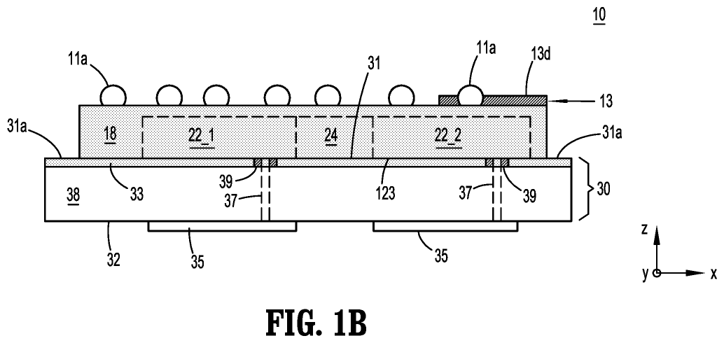

FIG. 1A is a plan view of an example subassembly 10 of an antenna apparatus according to an embodiment. FIG. 1B is an end view of subassembly 10. It is noted here that in the various end views and cross-sectional views herein, distal features in the views may sometimes be omitted for clarity of illustration.

Referring to FIGS. 1A and 1B, subassembly 10 may include an antenna substrate 30; a plurality of antenna elements 35; a plurality of semiconductor components 22_1 to 22_4 and 24 of a beamforming network (BFN); “first” molding material 18; solder bumps (e.g., balls) 11a-11d; and a redistribution layer (RDL) 13 with conductive traces 13a-13d.

Semiconductor components 22_1 to 22_4 will hereafter be exemplified as amplifier chips, each of which may be radio frequency (RF) coupled to one or more antenna elements 35. The RF coupling may be through vias 37 which may serve as antenna feeds for antenna elements 35 embodied as printed antenna elements (e.g., probe feeds or edge feeds for patch or dipole elements) formed on a lower surface 32 of antenna substrate 30. Semiconductor component 24 will hereafter be exemplified as a phase shifter chip 24, which may include a plurality of phase shifters, each for phase shifting a transmit signal output to one of amplifier chips 22 and/or for phase shifting a receive signal received by one or more antenna elements 35 and amplified by one of amplifier chips 22. Accordingly, phase shifter chip 24 may be RF coupled to amplifier chips 22_1 to 22_4 through respective conductive traces 13c. To control the respective phase shifts, phase shifting control signals, originating from control circuitry of the antenna apparatus (not part of subassembly 10), may be provided to phase shifter chip 24 from one or more solder bumps 11b connected between the control circuitry and respective conductive traces 13b. Similarly, to control biasing of an amplifier within an amplifier chip 22, a biasing voltage may be provided to the amplifier from the control circuitry through a solder bump 11a and a conductive trace 13a.

Because solder bumps 11 may be relatively large compared to the upper surface areas of chips 22 and 24, conductive traces 13 may be “fan out” conductive traces that traverse outwardly beyond the peripheries of chips 22 and 24 in the horizontal plane to connect with solder bumps 11. There may be several solder bumps 11 associated with and surrounding each of chips 22 and 24 to supply desired signal voltages as well as individual ground connections.

A lower surface 123 of each amplifier chip 22 may be attached to an upper surface 31 of antenna substrate 30 by metal pillars. First molding material 18 may at least partially encapsulate each of amplifier chips 22 and phase shifter chip 24. First molding material 18 may be applied as part of a first embedding process step, whereas “second” molding material described later may be applied as part of a second embedding process step to adhere antenna subassemblies 10 to one another (e.g., following individual RF/electrical testing of the individual antenna subassemblies 10). As seen in FIG. 1A, openings 28 within the molding material 18 may exist in areas directly above central regions of amplifier chips 22. The openings 28 may provide an air interface for the central regions, allowing heat transfer from amplifier chips 22 to the air.

Antenna substrate 30 may have a lower portion composed of dielectric material 38, e.g., a low loss dielectric such as quartz, glass or fused silica. An upper portion of antenna substrate 30 may include an antenna ground plane 33 proximate to or forming a part of upper surface 31. A peripheral upper surface 31a of antenna substrate 30 may extend beyond the edges of the first molding material 18 in the horizontal plane (x-y plane of FIGS. 1A and 1B). Peripheral upper surface 31a may provide a base for a combiner/divider component (discussed below) to be arranged between adjacent subassemblies 10. (The combiner/divider component may connect to phase shifter chip 24 through conductive trace 13d of RDL layer 13.) Each via 37 within antenna substrate 30 may extend vertically (z direction of FIGS. 1A and 1B) through dielectric 38 and an opening 39 within ground plane 33. A lower end of via 37 may electrically connect to an antenna element 35 and an upper end of via 37 may connect to an electrical contact of an amplifier chip 22. Opening 39 in ground plane 33 may be an isolation region to prevent shorting of via 37 to ground plane 33.

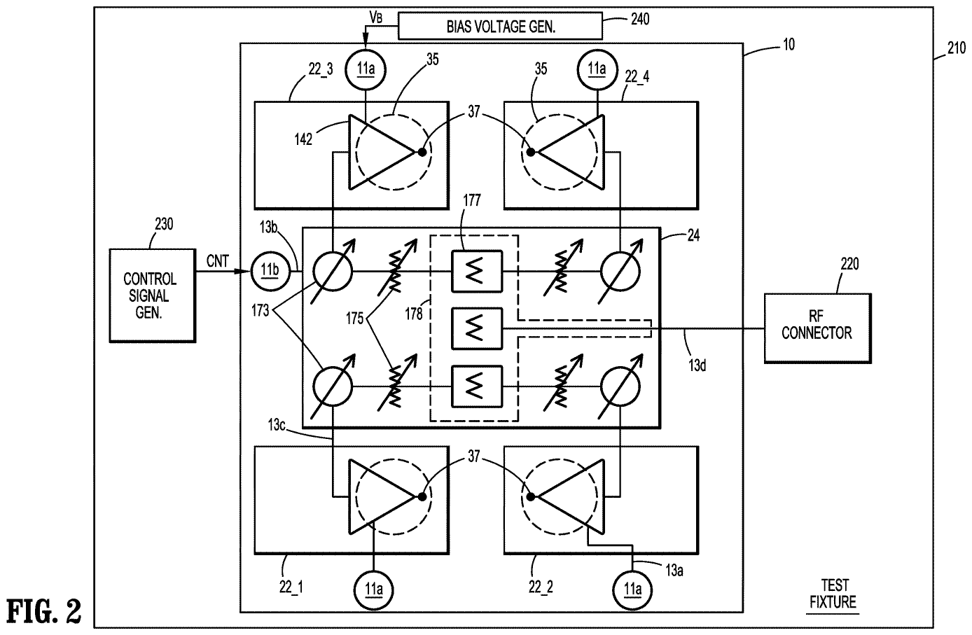

In embodiments where subassembly 10 includes a plurality of antenna elements 35 (as in FIGS. 1A and 1B), subassembly 10 may be a subarray within an overall antenna array (e.g., antenna apparatus 100 of FIG. 2A discussed below). In other embodiments, subassembly 10 is modified to include just a single antenna element 35 and/or just a single semiconductor component such as an amplifier chip 22 or a phase shifter chip 24.

FIG. 2 is a schematic diagram depicting example BFN components of subassembly 10 and placement of the subassembly within a test fixture 210. As noted above, BFN components of subassembly 10 may include amplifier chips 22_1 to 22_4 and phase shifter chip 24. Phase shifter chip 24 may be primarily composed of a different semiconductor material than that of amplifier chips 22. In an example, phase shifter chip 24 is silicon (Si) or silicon germanium (SiGe) and may include complementary metal oxide semiconductor (CMOS) transistors; and amplifier chips 22 are primarily composed of indium phosphate (InP), gallium arsenide (GaAs) or another type of III-V semiconductor material. Any amplifier chip 22 may include at least one amplifier 142, e.g., at least one power amplifier (PA) in the case of a transmit-only antenna system, at least one low noise amplifier (LNA) in the case of a receive-only antenna system, or both a PA(s) and an LNA(s) for a transmit and receive antenna system. Any amplifier chip 22 may further include other circuitry (not shown) such as a bandpass filter(s) and an impedance matching section. Phase shifter chip 24 may include K phase shifters 173, each coupled to a respective amplifier 142 of one of K amplifier chips 22 (K=4 in this example); variable attenuators 175; and a K:1 combiner/divider 178 that may be constructed with multiple 2:1 combiner/dividers 177. Each amplifier 140 may receive a bias voltage V_{B} routed from a conductive trace 13a and a solder bump 11a. Each phase shifter 173 and/or variable attenuator 175 may receive a respective control signal CNT for dynamically setting the phase shift of phase shifter 173 and/or the attenuation of variable attenuator 175 to implement dynamic beam steering. Any amplifier chip 22 and/or phase shifter chip 24 may be an RF integrated circuit (RFIC) or a monolithic microwave integrated circuit (MMIC).

In other embodiments, instead of employing a single phase shifter chip 24, multiple chips may be used to form the individual phase shifters 173, attenuators 175 and/or K:1 combiner/divider 178. In still other embodiments, at least one amplifier 142, at least one phase shifter 173, and at least one variable attenuator 175 are included within a single semiconductor chip. However, one benefit of providing amplifier(s) 142 and phase shifters 173 in separate chips composed of different semiconductor materials is that the phase shifter chips may be made thinner in some examples (e.g., if composed of Si). This clears up real estate to incorporate a radiation shield (not shown) composed, e.g., of tantalum or tungsten, between phase shifter chip 24 and antenna substrate 30 to protect the phase shifter circuitry from radiation in certain environments (e.g., space-based and military applications). Examples of radiation shields and antenna apparatus structures incorporating the same are disclosed in co-pending PCT patent application no. PCT/US2023/024215, filed 1 Jun. 2023, entitled METHOD OF CREATING EMBEDDED COMPONENTS ON AN ANTENNA SUBSTRATE AND ANTENNA APPARATUS FORMED WITH SAME, the content of which is incorporated herein by reference in its entirety.

Test fixture 210 may include a control signal generator 230, a bias voltage generator 240 and an RF connector 220. When subassembly 10 is placed within test fixture 210, control signal generator 230 may connect to solder bump 11b to provide test control signals CNT to phase shifter chip 24; bias voltage generator 240 may connect to solder bumps 11a to provide respective test bias voltages VB to amplifiers 142; and RF connector 220 may connect to an input/output (I/O) port exemplified by conductive trace 13d. In other examples, solder bumps 11 are omitted at this stage (and added later after testing), and test connections are made with probes or otherwise directly to the conductive traces of RDL 13. It is noted here that for convenience of illustration, ground conductors of transmission lines and control/bias signal lines are not shown in some of the various figures herein. For instance, in the case of coplanar waveguide (CPW) transmission lines, ground conductors may be present on opposite sides of the RF signal line conductors such as 13c and 13d, and RF connector 220 has a corresponding ground conductor. Similarly, a pair of solder bumps 11b, one for receiving a signal voltage and the other for receiving a ground voltage, may be provisioned to receive each bias voltage V_{B}; and one pair of solder bumps 11a may be provisioned to receive each control signal CNT.

For embodiments in which subassembly 10 is configured as part of a transmitting antenna system (e.g., amplifiers 142 are power amplifiers of a transmitter), RF connector 220 may supply a test transmit signal to I/O port 13d. In embodiments wherein subassembly 10 is configured as part of a receiving antenna system, RF connector 220 may receive a receive path signal from phase shifter chip 24. For instance, subassembly 10 mounted within test fixture 210 may be placed in an antenna test range in which an RF test signal is transmitted towards subassembly 10. Antenna elements 35 receive the signal and provide respective element signals which are routed to amplifier chips 22, amplified by amplifiers 142 embodied as low noise amplifiers (LNAs), phase shifted, variably attenuated, and combined by phase shifter 24 to provide a composite receive signal at RF connector 220. The composite receive signal may then be evaluated with respect to desired performance metrics. Reciprocal operations may occur for testing antenna subarray 10 performance on transmit.

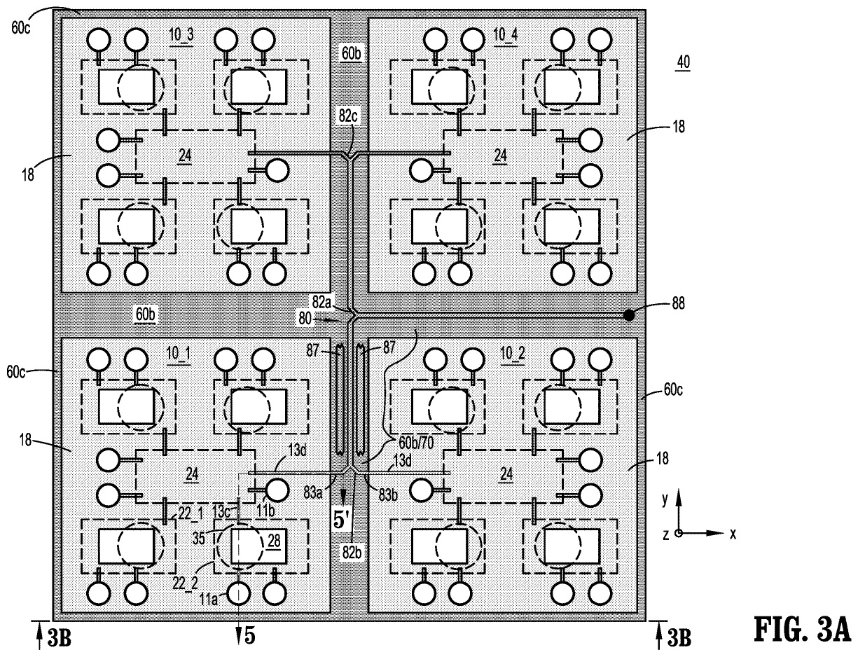

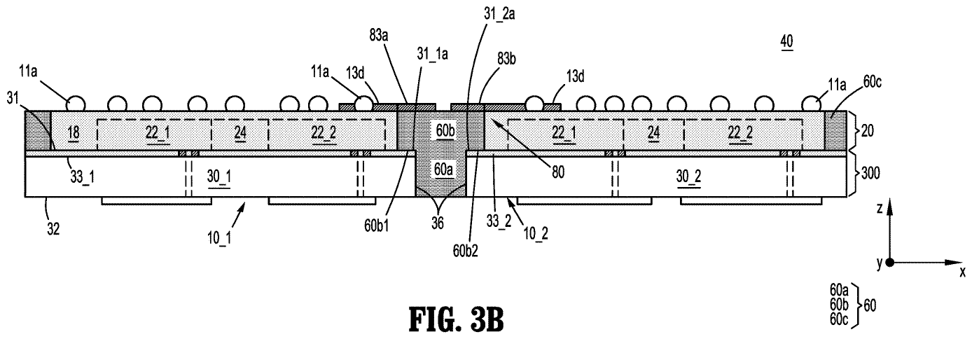

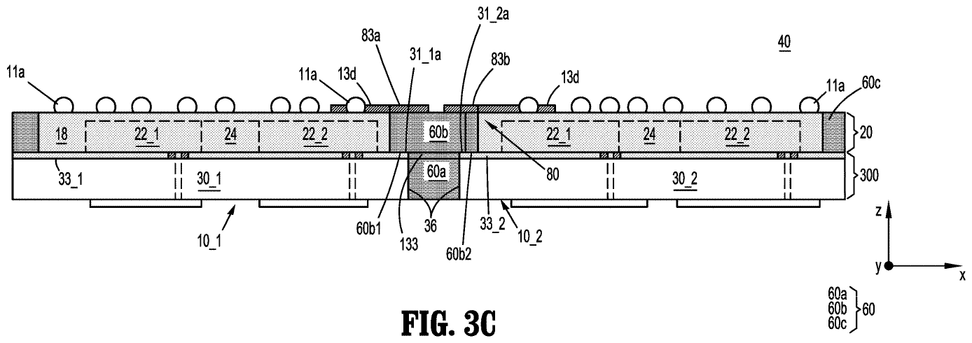

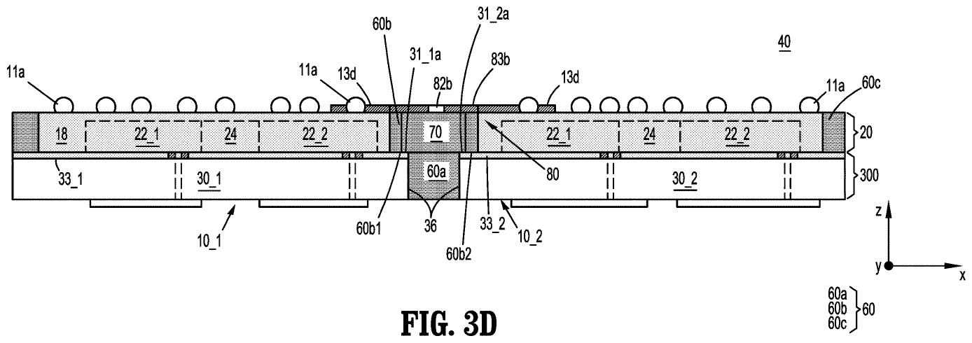

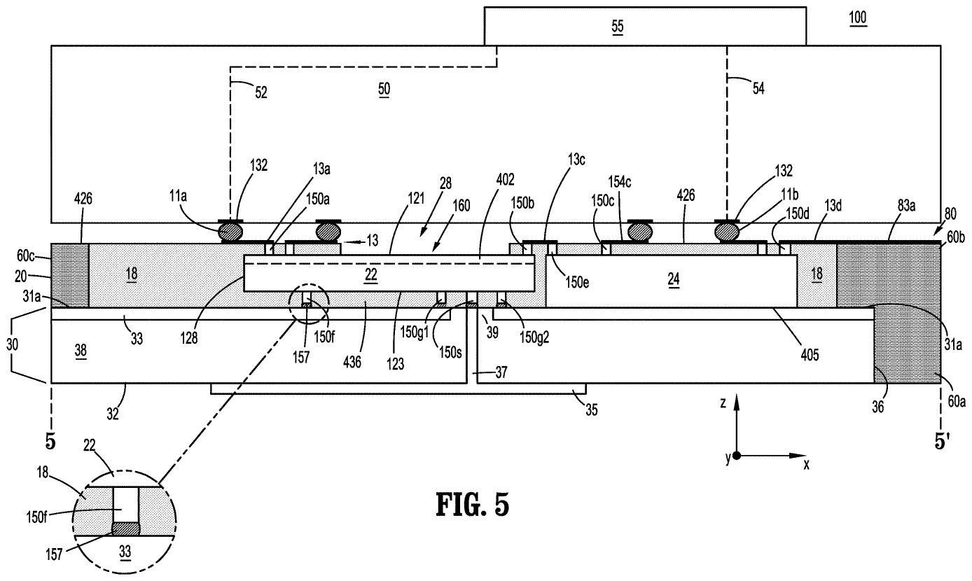

FIG. 3A is a plan view of an embedded antenna structure, 40, including a plurality of the subassemblies of FIGS. 1A and 1B adhered together. Embedded antenna structure 40 may form part of an embedded antenna array, such as antenna apparatus 100 of FIG. 5 discussed later. In this example, antenna structure 40 includes four subassemblies 10_1, 10_2, 10_3 and 10_4, arranged and adhered together side by side to form a planar antenna array of sixteen antenna elements 35.

FIG. 3B is an example end view of antenna structure 40. Referring to FIGS. 3A and 3B, subassemblies 10_1 to 10_4 may be adhered together by second molding material 60, which may include a lower molding portion 60a, a central molding portion 60b, and a peripheral molding portion 60c. A combiner/divider 80 of a resulting antenna array formed by subassemblies 10_1 to 10_4 may have portions disposed between subassemblies 10_1 to 10_4. In the illustrated example, combiner/divider 80 is a 1:4 combiner/divider including three 2:1 power divider/combiners 82a, 82b and 82c. A beamforming network (BFN) 20 for the antenna array may include combiner/divider 80, the phase shifter chips 24 of subassemblies 10_1 to 10_4, and the amplifier chips 22 of subassemblies 10_1 to 10_4.

A composite antenna substrate 300 may include each of the antenna substrates 30 adhered together with second molding material 60. Lower molding portion 60a may extend vertically from lower surface 32 to upper surface 31 of each antenna substrate 30, and may adhere side surfaces 36 of adjacent antenna substrates together. In the example of FIG. 3B, central molding portion 60b completely fills the region between edges of first molding material 18 of adjacent subassemblies 10_1 and 10_2 and is therefore wider than lower molding portion 60a in the x direction (the direction orthogonal to side surfaces 36). Here, left side and right side lower surface regions 60b1 and 60b2 of central molding portion 60b may be formed on peripheral surface portions 31_1a and 31_2a, respectively, of the upper surfaces 31 of antenna substrates 30_1 and 30_2. The same or similar structure may be provided between the other adjacent subassemblies 10_3 and 10_4; 10_1 and 10_3; and 10_2 and 10_4. In this case, central molding portion 60b may serve a dual function of i) partially adhering subassemblies 10_1 to 10_4 together, and ii) acting as a substrate of combiner/divider 80. In this regard, central molding portion 60b, in conjunction with conductive traces such as 83a-83c and 87, and conductive traces forming power divider/combiners 82a-82c, each printed atop central molding portion 60b, may together form combiner/divider 80. Alternatively, power divider/combiners 82a-82c are formed in chips suitably attached directly to antenna substrate 30 or on a lower level of central molding portion 60b. Any of such chips may further include an intermediate power amplifier forming part of combiner/divider 80.

In other embodiments discussed below (see FIG. 3D), the substrate for combiner/divider 80 is a separate dielectric substrate 70 such as alumina. In either of the above embodiments, signal conductors of combiner/divider 80, e.g., conductive traces 83a and 83b, may electrically connect to respective I/O conductive traces 13d of antenna subassemblies 10. For instance, once second molding material 60 is formed, central molding portion 60b may abut adjacent edges of molding material 18 beneath conductive traces 13d, such that conductive traces 83a and 83b may be printed in a manner overlapping conductive traces 13d, thereby forming desired connections. Alternatively, wirebonds are used to form the connections.

In any of the above embodiments, combiner/divider 80 may have a coplanar waveguide construction, in which case ground conductors 87 may be disposed on opposite sides of the inner conductors; and ground conductors (not shown) may run on opposite sides of I/O conductive traces 39, which may be connected to ground conductors 87 through plating or wirebonding. Alternatively, each of the conductive traces 13d and the signal conductors 83 are signal conductors of microstrip transmission lines, in which case ground plane 33 and/or suitable ground conductors are provided for the microstrip grounds.

In an embodiment having the structure of FIG. 3B, ground planes 33_1 and 33_2 of adjacent subassemblies are electrically separated partially or entirely. The use of separated ground planes in this manner may reduce the likelihood of surface waves, particularly for the case of beamforming with high scan angles. For embodiments in which the ground planes of adjacent subassemblies are only partially separated (i.e., gaps are present in some places), the gaps may create resonant structures that prevent certain frequencies from propagating.

FIG. 3C is an end view of an example embedded antenna structure 40 having a composite ground plane without electrical separation between individual subassembly ground planes. In this example, an interconnect 133 electrically connects ground planes 33 of adjacent subassemblies, e.g., the ground planes 33_1 and 33_2 of adjacent subassemblies 10_1 and 10_2, and the ground planes 33 of the other pairs of adjacent subassemblies, 10_3 and 10_4; etc. To form interconnect 133, lower molding portion 60a and central molding portion 60b may be formed in separate process steps and interconnect 133 may be formed between these process steps. If lower molding portion 60a is formed first, interconnect 133 may be printed (e.g., electroplated) on a top surface of lower molding portion 60a, e.g., in a manner overlapping abutting adjacent portions of ground planes 33_1 and 33_2 to ensure a reliable electrical connection. Alternatively, interconnect 133 is a conductive epoxy, solder paste, solder cap layer, or a combination of a printed conductor with conductive epoxy or solder applied at least to junctions atop the interfaces between lower molding portion 60a and side surfaces 36. In another example, interconnect 133 is a thin metal plate that is soldered to the adjacent portions of ground planes 33-1 and 33_2. In any case, central molding portion 60b may thereafter be formed on the upper surface of interconnect 133. If central molding portion 60b is formed first, interconnect 133 may be formed in a similar manner upon the lower surface of central molding portion 60b, after which lower portion 60a may be formed on the lower surface of interconnect 133.

FIG. 3D is an end view of an example embedded antenna structure 40 in which combiner/divider 80 is embodied with a separate dielectric substrate 70. In one example, dielectric substrate 70 is comprised of one more sections of alumina. Any of the examples for interconnect 133 described above may be formed at the lower surface of dielectric substrate 70. However, when conductive epoxy is used for interconnect 133, it may serve the dual purpose of electrically connecting adjacent ground planes 33_1 and 33_2, and also adhering dielectric substrate 70 to lower molding portion 60a. Peripheral lower surface portions of dielectric substrate 70 may also be adhered by the conductive epoxy to upper peripheral surfaces 31a of subassemblies 10_1 and 10_2. In an embodiment with separated ground planes 33_1 and 33_2 (as in FIG. 3B), non-conductive epoxy may be used to adhere dielectric substrate 70 to lower molding portion 60a and the adjacent surfaces.

To form combiner/divider 80 of FIG. 3D (with or without interconnect 133), once dielectric substrate 70 is adhered to the surfaces directly below, the second molding material of central molding portion 60b may be applied in gaps on the sides of dielectric substrate 70 facing first molding material 18. Thereafter, the conductive traces 83 and 87 may be formed atop dielectric substrate 70 and connected to conductive traces 13d and ground conductors of subassemblies 10, and power divider/combiners 82 may be formed/attached, in the same manner as described above in connection with FIG. 3B.

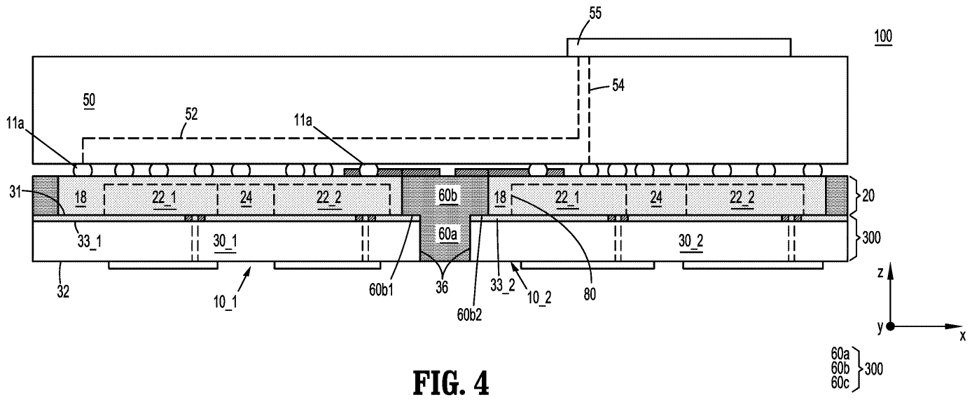

FIG. 4 is an end view of an example antenna apparatus, 100, which includes the embedded antenna structure 40 described above. Antenna apparatus 100 includes a printed wiring board (PWB) 50 attached to the upper portion of BFN 20 through solder bumps 11. The profile of PWB 50 in the horizontal plane may approximately coincide with the profile of embedded antenna structure 40. PWB 50 may include conductive pads 132 at a lower surface and control circuitry 55 such as a field programmable gate array (FPGA) at an upper surface. Bias voltages may be provided from control circuitry 55 to amplifiers 142 of amplifier chips 22 through conductive paths 52 and conductive pads 132 connected to conductive traces 13a through solder bumps 11a. Phase shifter/variable attenuator control signals may be provided to phase shifter chips 24 through conductive paths 54 and conductive pads 132 connected to conductive traces 13b through solder bumps 11b. PWB may also include an RF connector (not shown) for applying an input transmit signal and/or receiving a composite receive signal to an I/O port 88 of combiner/divider 80 through a suitable transition, e.g., a coaxial to CPW transition.

FIG. 5 is a cross-sectional view of the antenna apparatus 100 of FIG. 4, depicting an example configuration of antenna structure 40 of FIG. 2A along the path 5-5′, and a corresponding portion of PWB 50. For brevity, features described above with reference to FIGS. 1A-4 may not be re-described below.

Although one amplifier chip 22 and one phase shifter chip 24 of subassembly 10_1 is depicted in the example, the same basic structure may exist throughout antenna apparatus 100.

Amplifier chip 22 may have a lower surface 123 attached to antenna substrate 30 through metal pillars (or bumps) 150, such as metal pillars 150f, 150s, 150g1 and 150g2. Examples of metal pillars 150 include copper pillars, gold pillars, platinum pillars and mixed alloy pillars. In FIG. 5, metal pillars 150 are formed on lower surface 123 of amplifier chip 22, and a solder cap 157 is formed on each lower surface of these metal pillars 150. When melted, solder caps 157 adhere the respective metal pillars 150f, 150g1 and 150g2 to electrical connection points on ground plane 33 to form electrical and mechanical connections. First molding material 18 may partially or fully encapsulate amplifier chip 22 and phase shifter chip 24.

Upper surfaces of metal pillars 150f, 150g1 and 150g2 may electrically connect to ground contacts (not shown) within amplifier chip 22. An upper surface of metal pillar 150s electrically connects to a “signal contact” (not shown) within amplifier chip 22. Via 37 has a lower end connected to antenna element 140 and an upper end connected to metal pillar 150s through a solder cap 157 on metal pillar 150s, to form a probe feed for antenna element 140. Metal pillars 150s, 150g1 and 150g2 may form a “ground-signal-ground” (GSG) transition (or “GSG connection”) between amplifier chip 22 and antenna substrate 30. A dielectric or air region 39 may annularly surround the upper end of via 37 to isolate the same from ground plane 33 and complete the GSG transition. Alternatively, one of metal pillars 150g1 or 150g2 is omitted, whereby a ground-signal (GS) transition is substituted for the GSG transition.

The lower metal pillars 150f, 150g1 and 150g2 may be alternatively formed on ground plane 33, and metal pillar 150s may be alternatively formed on the upper end of via 37. In this case, solder caps 157 may be disposed on the upper surfaces of the lower metal pillars 150 for connection to respective metal contacts on lower surface 123 of amplifier chip 22. Whether the lower metal pillars 150 are pillars formed on the lower surface 123 of amplifier chip 22 or the upper surface 31 of antenna substrate 30, a region 436 surrounding the lower metal pillars 150f, etc. may be filled with first molding material 18. Alternatively, region 436 is filled with an underfill material different from molding material 18. In another embodiment, region 436 is an air-filled region. The underfill material may be a dielectric material that acts as a glue. Examples include epoxy materials with a silicon filler designed to minimize coefficient of thermal expansion (CTE) mismatch.

Phase shifter chip 24 may be attached to antenna substrate 30 with a suitable adherent 405 such as a solder cap layer or an adhesive. Upper metal pillars such as 150a and 150b may be formed on upper surface 121 of amplifier chip 22. Similarly, upper metal pillars such as 150c, 150d and 150e may be formed on the upper surface of phase shifter chip 24. The upper surface 121 of amplifier chip 22 may be coplanar with the upper surface of phase shifter chip 24. Upper metal pillars such as 150a to 150e may be formed with substantially uniform dimensions, such that their upper surfaces are also coplanar. First molding material 18 may surround and interface with peripheral surfaces 128 of amplifier chip 22 (orthogonal to upper surface 121 and lower surface 123) as well as peripheral surfaces of phase shifter chip 24 and combiner/divider 80. Air gap 28 may have been formed directly above a central (e.g., majority) portion 160 of upper surface 121 of amplifier chip 22. An active region 402 of amplifier chip 22 with active circuitry (doped regions of transistors forming drain to source conductive channels, etc.) may be located directly behind upper surface 121. The majority or substantially the entirety of active region 402 may interface with air gap 28 rather than first molding material 18, allowing for better thermal dissipation of the active circuitry. Some examples of both first molding material 18 and second molding material 60 include molding materials typically used in Fan Out Wafer Level Packaging (FOWLP); an epoxy mold compound (EMC); a liquid crystal polymer (LCP); and other plastics such as polyimide. First molding material 18 may be the same or different material as second molding material 60. The composition and width of second molding material 60 corresponding to designed gaps between adjacent antenna substrates 30 may be selected to minimize the likelihood of antenna substrates 30 cracking over a range of environmental conditions, in particular, over a wide temperature range. In some examples, the width of central molding portion 60b between adjacent subassemblies 10 is in the range of 1-3 mm, and the width of lower molding portion 60a is on the order of 100 μm.

First molding material 18 may also extend uniformly above upper surface 121 of amplifier chip 22 and cover peripheral portions of upper surface 121 (outside the periphery of central portion 160). First molding material 18 may also be uniformly disposed on the top surface of phase shifter chip 24, such that a top surface 426 of first molding material 18 is coplanar with an upper surface of second molding material 60b, and is coplanar at regions atop amplifier chip 22, phase shifter chip 24, upper surfaces of metal pillars 150a to 150e, etc. In this manner, redistribution layer (RDL) 13 (including conductive traces 13a to 13d) formed atop surface 426 may electrically connect desired metal pillars/connection points between separated BFN components. For instance, metal pillar 150b formed on amplifier chip 22 connects to metal pillar 150e formed on phase shifter 24 through RDL conductive trace 13c. Likewise, metal pillar 150d of phase shifter chip 24 may connect to conductive trace 83a of combiner/divider 180 through RDL conductive trace 13d. Note that while RDL 13 is shown to include a single metal layer in FIG. 5, RDL 13 may include multiple metal layers (separated by isolation layers) in alternative examples.

In other embodiments, RDL 13 has electrical contacts that are connected directly to electrical contacts (not shown) of amplifier chip 22 at its upper surface 121. In this case, the upper metal pillars 150a, 150b, etc. may be omitted and the thickness of the molding material 18 atop amplifier chip 22 may be reduced or the molding material atop amplifier chip 22 is omitted. Other conductive traces of RDL 13 are fan out conductive traces such as 13a and 13b that connect metal pillars 150 to the larger solder bumps 11 located beyond the peripheries of the respective chips 22, 24. A solder bump 11 may be a ball with a diameter in the range of 0.075 to 1.8 mm whereas a metal pillar 150 may have a largest cross-sectional dimension (in the xy plane) in the range of 10-150 μm. Amplifier chip 22 may have a parallelepiped geometry (e.g., rectangular or square cuboid), with a surface area (in the xy plane) in the range of 0.25 mm² to 25 mm² and a largest cross-sectional dimension (in the xy plane) in the range of 0.5 mm to 5 mm. Phase shifter chip 24 may have similar cross-sectional dimensions (but may be made substantially thinner in some examples). Accordingly, because solder bumps 11 are large relative to the surface areas of upper surface 121 of amplifier chip 22 and the upper surface area of phase shifter chip 24, the fan out traces 13a, 13b, etc. facilitate/make possible connections from each chip 22, 24 to multiple solder bumps 11. Solder bumps 11 may connect to PWB 50 via contact pads 132, which in turn connect to signal lines such as 52 and 54 within PWB 50 as discussed earlier.

Antenna elements 35, when embodied as microstrip patches, may have any suitable shape such as circular, square, rectangular, elliptical or variations thereof, and may be fed and configured in a manner sufficient to achieve a desired polarization, e.g., circular, linear, or elliptical. The number of antenna elements 35 within antenna apparatus 100, their type, sizes, shapes, inter-element spacing, and the manner in which they are fed may be varied by design to achieve targeted performance metrics. In a typical embodiment antenna apparatus 100 may include tens, hundreds or thousands of antenna elements 35. In embodiments described above, each antenna element 35 may be a microstrip patch fed with a probe feed (which herein encompasses a side feed to the patch), implemented with a via 37. In other examples, an electromagnetic feed mechanism is used instead of a via, where each antenna element 35 is excited from a respective feed point with near field energy.

Antenna apparatus 100 may be configured for operation over a millimeter (mm) wave frequency band, generally defined as a band within the 30 GHz to 300 GHz range. In other examples, antenna 100 operates in a microwave range from about 1 GHz to 30 GHz, or in a sub-microwave range below 1 GHz. Herein, an RF signal denotes a signal with a frequency anywhere from below 1 GHZ up to 300 GHZ.

The example structure of antenna apparatus 100 illustrated in FIG. 5 may be modified in a variety of ways. For instance, a thin RDL region may be added between ground plane 33 and first molding material 18, and vias may be formed within first molding material 18 to bring voltages and signals from PWB 50 to lower contacts of chips 22 and 24 through this RDL region. In another example, a radiation shield may be disposed between phase shifter chip 24 and antenna substrate 30. If the addition of the radiation shield raises the upper surface of phase shifter chip 24 above the upper surface of amplifier chips 122, phase shifter chip 24 may be flipped around such that the electrical contacts for receiving control signals face the radiation shield. A redistribution layer akin to RDL 13 may then be formed between the radiation shield and the lower surface of phase shifter chip 24, which redistribution layer may connect the lower electrical contacts of phase shifter chip 24 to each of the signal lines within PWB 50, upper surface electrical contacts of amplifier chips 22, and conductive trace 13d. The redistribution layer may be formed directly on the upper surface of the radiation shield, or alternatively on a molding layer formed atop the radiation shield.

It is noted here that in embodiments where the gap between adjacent substrates 30 of adjacent subassemblies 10 is designed to be small (e.g., adjacent substrates 30 are approximately butted together), lower molding portion 60a may be omitted and the gap it previously occupied, between adjacent substrates 30, may be just air. In this case, central molding portion 60b in conjunction with peripheral molding portion 60c may collectively provide sufficient adhesive force to adhere the subassemblies 10 together to form antenna structure 40 as a robust integrated structure.

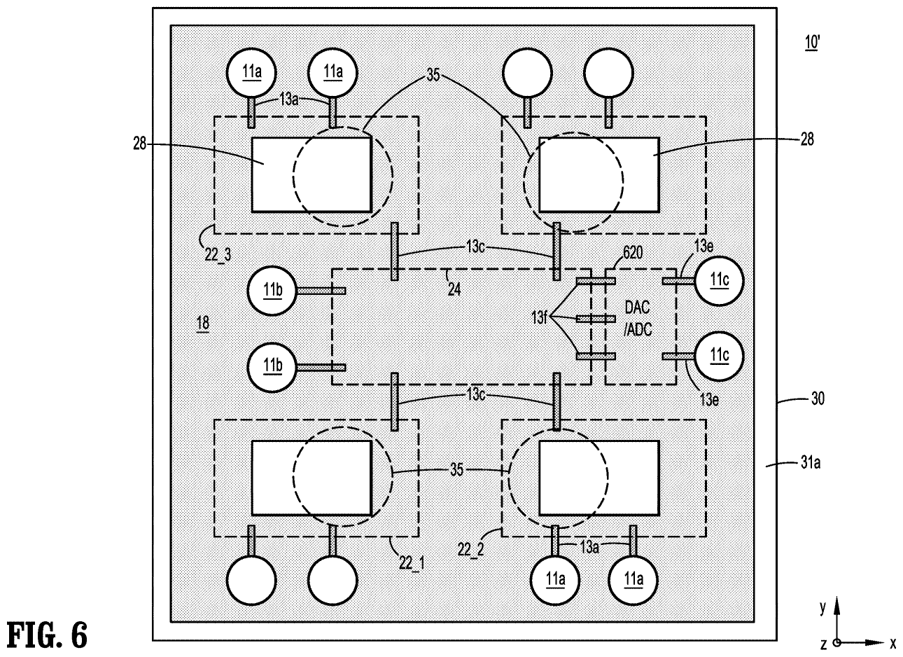

FIG. 6 is a plan view of an example subassembly, 10′, of an antenna apparatus configured to implement digital beamforming, hybrid digital beamforming, or multi-beam operations. Subassembly 10′ differs from subassembly 10 described above by incorporating at least one integrated circuit (IC) 620 including a digital to analog converter (DAC) and/or an analog to digital converter (ADC). (IC chip(s) 620, shown in phantom. IC chip(s) 620 may be adhered to antenna substrate 30 and at least partially encapsulated by first molding material (with a portion of RDL 13 formed directly above), in the same manner as phase shifter chip 24 and/or amplifier chips 22, and when so adhered may have an upper surface approximately coplanar with chips 22 and/or 24. With this approach, an electronically steerable antenna array such as a phased array antenna may be formed using a digital domain technique without the need for an analog combiner/divider 80 to combine/divide RF signals from/to individual subarrays. With the digital domain technique, a digital domain combiner/divider (not shown) may be implemented in a processor of PWB 50 to achieve electronic beam steering. In other embodiments, signals output from IC chip(s) 620 to PWB 50 are not combined digitally but instead kept separate to achieve multi-beam or sum/delta monopulse beam tracking by suitable processing within a processor of PWB 50.

IC chip(s) 620 may be RF coupled to phase shifter chip 24 through RDL conductive traces 13f to receive a phase shifted receive signal in a receive path and/or provide an input transmit signal in a transmit path. IC chip(s) 620 may be coupled to control/processing circuitry of PWB 50 through conductive traces 13e and solder bumps 11c. In the receive path of some embodiments, IC chip 620 includes capability for direct conversion of RF signals from phase shifter chip 24 into baseband digital signals. In other embodiments, IC chip 620 includes a downconverter to convert the RF signals into intermediate frequency (IF) signals or baseband signals prior to conversion thereof into digital signals. RF/electrical testing of individual subassemblies 10′ prior to being attached together may be performed in a similar manner as described above for subassemblies 10.

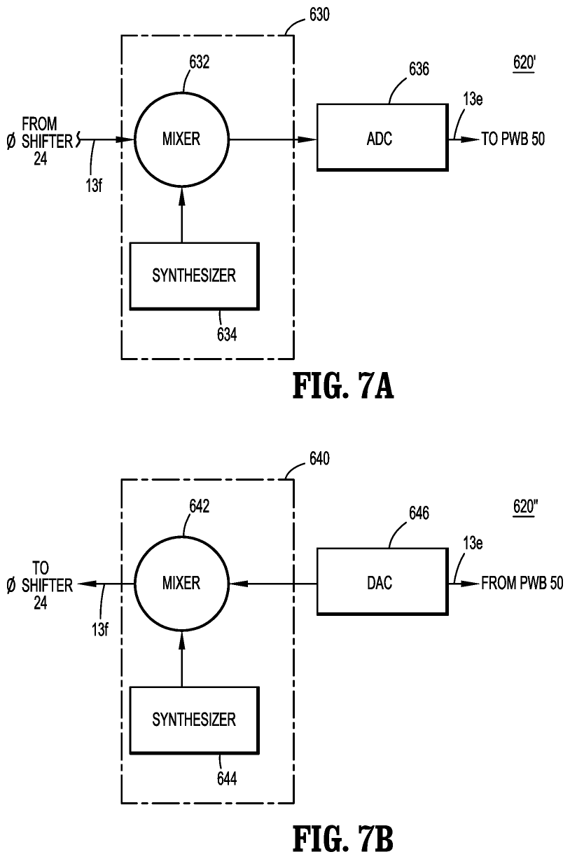

FIG. 7A schematically illustrates example receive path circuitry 620′ of IC chip(s) 620. Circuitry 620′ includes an ADC 636 and a downconverter 630 comprised of a synthesizer 634 and a down-conversion mixer 632. Mixer 632 downconverts RF signals from phase shifter 24 to IF or baseband signals by mixing a local oscillator (LO) signal from synthesizer 634 with the RF signals. The downconverted signals are converted to digital signals by ADC 636 and may be processed by a processor of PWB 50 (e.g., FGPA 55) to form a receive beam. Downconverter 630 may be formed in a separate chip from ADC 636, in which case the two chips may be interconnected by conductive traces of RDL 13. In embodiments in which subassembly 10′ is one of a plurality of subassemblies that cooperate to form a common beam of a phased array, the digital signal output from ADC 636 may be combined with similar digital signals from one or more other subassemblies 10′ to form a composite receive signal of the phased array.

FIG. 7B schematically illustrates example transmit path circuitry 620″ of IC chip(s) 620. Circuitry 620″ includes a DAC 646 and an upconverter 640 comprised of a synthesizer 644 and an upconversion mixer 642. DAC 646 may receive digital transmit path signals from a processor of PWB 50 and convert the same to analog baseband signals. Mixer 642 upconverts the baseband signals from DAC 646 to RF signals by mixing the baseband signals with an LO signal from synthesizer 644. The RF signals are then output to phase shifter chip 24 to be further processed and transmitted by antenna elements 35. Note that upconverter 640 may be formed in a separate chip from DAC 646, in which case the two chips may be interconnected by conductive traces of RDL 13. In embodiments in which subassembly 10′ is one of a plurality of subassemblies that cooperate to form a common beam of a phased array, each subassembly 10′ may receive synchronized digital signals and/or timing signals from a processor of PWB 50 to enable synchronized transmit signals to be generated by each of the subassemblies 10′ and thereby form a composite transmit beam of a phased array.

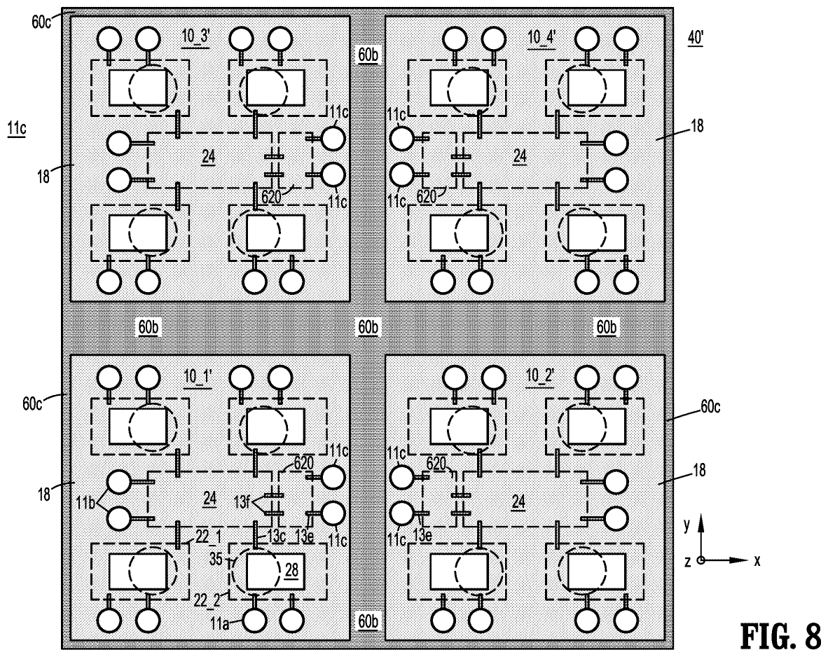

FIG. 8 is a plan view of an embedded antenna structure, 40′, including a plurality of the subassemblies of FIG. 6 adhered together. In this example, four subassemblies 10_1′, 10_2′, 10_3′ and 10_4′, each configured as shown and described above with respect to FIGS. 6-7B, are adhered together to form a phased array of sixteen elements. Since beams are formed in the digital domain, combiner/divider 80 is omitted and replaced with central portion 60b of second molding material 60 to adhere adjacent subassemblies together (lower portion 60a, if included, may be disposed centrally below central portion 60b). PWB 50 (not shown) may overlay antenna structure 40′ in the same manner as depicted in FIG. 5, and communicate signals to/from subassemblies 10_1′ to 10_4′ through solder bumps 11a-11c. Other aspects of antenna structure 40′ may be the same as described above for antenna structure 40.

The subassemblies 10′ of FIGS. 6-7B and the embedded antenna structure 40′ of FIG. 8 may be modified by including at least some of the circuitry of IC chip 620 within phase shifter chip 24. Alternatively or additionally, at least some of the circuitry of IC chip 620 may be included in the region occupied by central portion 60b of the second molding material 60.

In the above-discussed embodiments, the subassemblies such as 10_1 to 10_4 and 10_1′ to 10_4′ have been described as being cooperatively coupled to one another, in either the analog domain (RF coupled with combiner/divider 80) or the digital domain (with an effective digital combiner/divider), to form an electronically steerable antenna array, e.g., a phased array. However, in other embodiments, each of the subassemblies is its own antenna array that forms Its own beam, independent of beams formed by the other subassemblies. Thus, an analog combiner/divider 80 and a digital combiner/divider may be omitted in these embodiments. For instance, each subarray 10 or 10′ may form a beam that transmits/receives signals at a different respective frequency. Alternatively or additionally, each subarray 10 or 10′ may form a beam that points in a different direction, by suitable phase shifting/amplitude adjustment of signals communicated by the antenna elements 35 of the individual subarray.

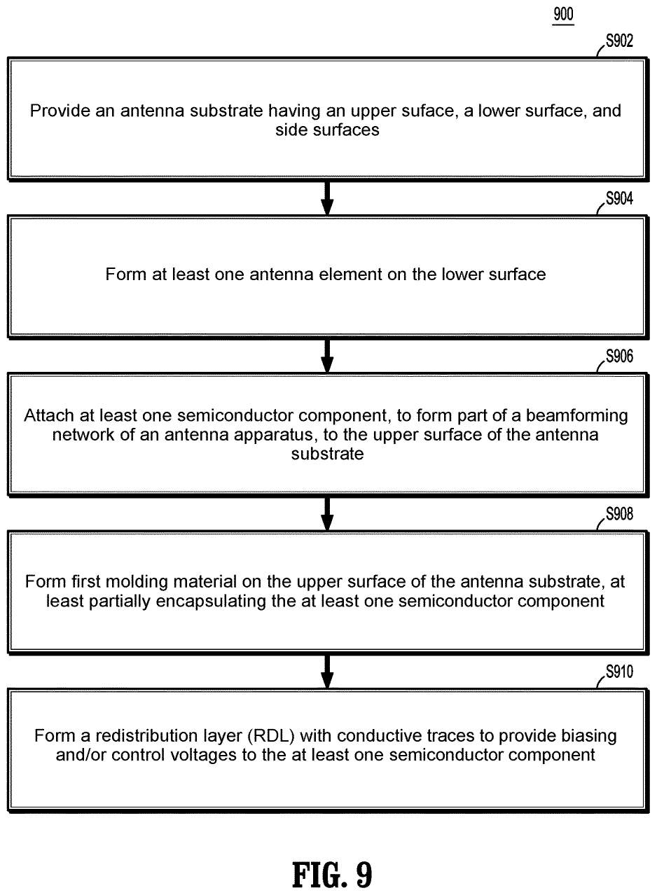

FIG. 9 is a flow diagram of an example method, 900, for fabricating an antenna subassembly, e.g., subassembly 10 or 10′, of an antenna apparatus according to an embodiment. The order of process steps in method 900, as well as in other methods described herein, may be changed or combined with other steps as desired, unless the context indicates otherwise. With method 900, an antenna substrate having an upper surface, a lower surface, and side surfaces may be provided (S902). At least one antenna element may be formed on the lower surface (S904). Additionally, in preparing the antenna substrate, a ground plane may be formed proximate to or on the upper surface, and at least one via may be formed within the antenna substrate and connected on a lower end to the antenna element. Note that the antenna substrate (“subassembly antenna substrate”), such as antenna substrate 30 described above, may be formed by first preparing a larger antenna substrate with a larger number of antenna elements and vias, and then dicing the subassembly antenna substrate from the larger antenna substrate. Such dicing may be performed before or after analogous dicing of a semiconductor wafer with embedded BFN components. After the semiconductor wafer is attached to the larger antenna substrate and the first molding 18 is applied to embed the semiconductor components, the dicing of the semiconductor wafer and the larger antenna substrate to form individual subassemblies 10 may be performed simultaneously.

At least one semiconductor component (e.g., amplifier chips 22 and/or phase shifter chips 24), which will form part of a BFN of a final antenna array apparatus, is attached to the upper surface of the antenna substrate (S906). Such attachment may be accomplished by forming metal pillars with solder caps on the bottom surface of the semiconductor component or on the upper surface of the antenna substrate. First molding material may be formed on the upper surface of the antenna substrate (e.g., by applying and curing the same), at least partially encapsulating (embedding) the at least one semiconductor component (S908). The first molding material may be formed (with the at least one semiconductor component embedded) to be concentric with the antenna substrate. Additionally, in the horizontal plane, a profile of the first molding material with the at least one semiconductor embedded may be smaller than a profile of the antenna substrate, so that peripheral upper surfaces of the antenna substrate are exposed for a subsequent formation of second molding material thereon (when subassemblies are adhered together).

When the at least one semiconductor component includes at least one amplifier chip, the first molding material may be omitted/removed from a central portion of the amplifier chip. A redistribution layer (RDL) may be formed with conductive traces to provide biasing and/or control voltages to the at least one semiconductor component (S910). Once the RDL is formed, RF/electrical testing of the antenna subassembly may be performed. Note that solder bumps may be formed on the RDL before or after the RF/electrical testing.

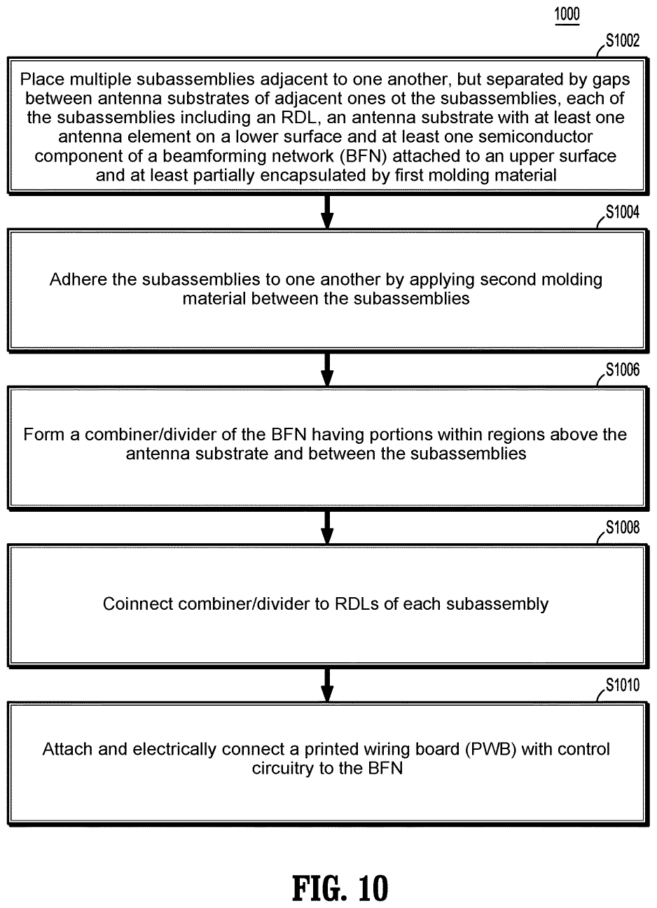

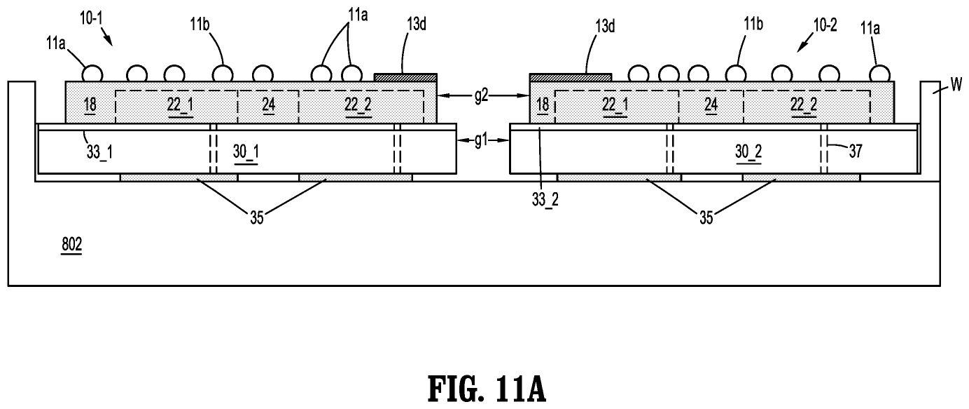

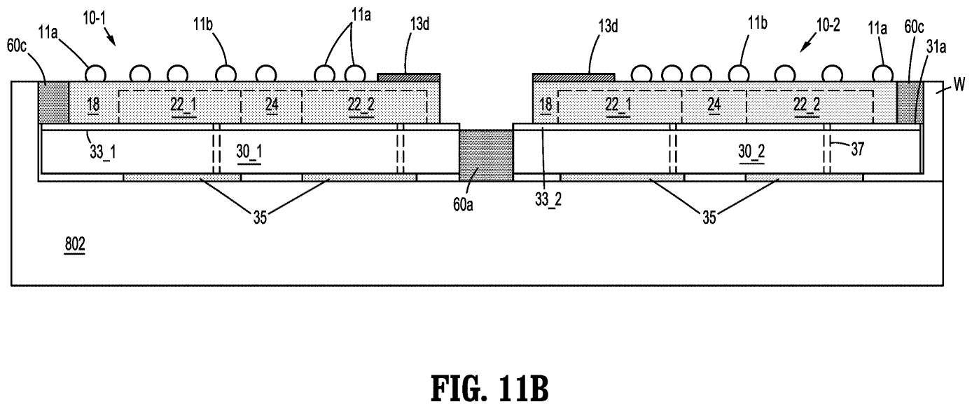

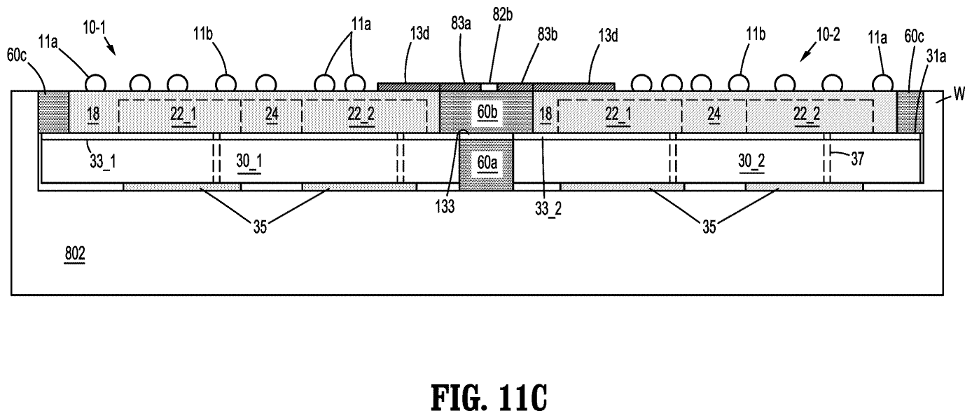

FIG. 10 is a flow diagram of an example method, 1000, of fabricating an antenna array apparatus including a plurality of antenna subassemblies, such as subassemblies each fabricated according to the method 900 just discussed. Multiple subassemblies may be placed adjacent to one another, but separated by gaps between antenna substrates of adjacent subassemblies (S1002). For example, as illustrated in FIG. 11A, subassembly 10_1 is placed side by side with subassembly 10_2 in a fixture 802, with antenna substrates 30_1 and 30_2 separated by a gap “g1” and adjacent edges of first molding material 18 separated by a gap g2. Fixture 802 may have a base surface supporting the lower surfaces of the antenna substrates, and a peripheral wall W abutting a side surface of one or more subassemblies.

The adjacent subassemblies may then be adhered to one another by forming (e.g., applying and curing) second molding material between the adjacent subassemblies, i.e., within gaps g1 and/or g2 (S1004). (Note that the lower portion 60a of the second molding material 60 may be omitted if gaps g1 are small enough. For instance, as shown in FIG. 11B, lower portion 60a of second molding material 60 may be formed between substrates 30_1 and 30_2, and peripheral portion 60c of second molding material 60 may be formed upon outmost upper surfaces 31a of each of antenna substrates 30_1 and 30_2 and adjacent to outermost surfaces of first molding material 18. If the ground planes (e.g., 33_1 and 33_2) of the adjacent subassemblies are not to be electrically connected to suppress potential surface waves, the application of the second molding material 60 may continue to the upper surface of first molding material 18 and thereby fill the gap g2 between the adjacent edges of first molding material 18 (e.g., upper portion 60b fills the gap g2 as shown in FIG. 3B). For embodiments in which the adjacent ground planes are to be connected, an interconnect 133 may be formed atop lower portion 60a using one of the techniques described earlier, as illustrated in FIG. 11B.

It is noted here that another way to prevent surface waves is to replace the lower molding material 60a with conductive or absorptive material. In some embodiments, this is done without electrically separating adjacent ground planes 33. In other embodiments, this is done in conjunction with providing partially or completely separated ground planes 33.

A combiner/divider 80 of the BFN may then be formed having portions within regions above the antenna substrates and between the subassemblies (S1006). (Combiner/divider 80 may be omitted and just replaced with second molding material 60b for digital beamforming embodiments as described above.) For instance, as shown in FIG. 11C for an embodiment including the electrical interconnect 133, central portion 60b of the second molding material may be formed. Conductive traces such as 83a, 83b may thereafter be formed atop central portion 60b to form the combiner/divider 80; these conductive traces may be connected to adjacent RDL conductive traces 13d using one of the techniques described earlier (S1008). Alternatively, a dielectric substrate 70 is adhered to the upper surface of lower portion 60a and conductive traces 83 are formed on its upper surface and connected to conductive traces 39 as described earlier. A PWB may thereafter be attached and electrically connected to the interim structure by placing the same against solder bumps 11 and melting and cooling the solder (S1010). The antenna assembly may be removed from fixture 802 and additional components may be added to the assembly.

Embodiments of an antenna apparatus as described above may exhibit superior reliability due to reduced likelihood of antenna substrate breakage as a result of the composite construction with molding material adhering adjacent antenna substrates together. Embodiments may also be amenable to improved manufacturing yield due to the ability to RF test and electrically test individual subassemblies prior to a final assembly. In addition, embodiments may be formed with a low profile and may therefore be particularly advantageous in constrained space applications.

While the technology described herein has been particularly shown and described with reference to example embodiments thereof, it will be understood by those of ordinary skill in the art that various changes in form and details may be made therein without departing from the spirit and scope of the claimed subject matter as defined by the following claims and their equivalents.

1. An antenna apparatus comprising:
a plurality of subassemblies each comprising:
an antenna substrate having an upper surface and a lower surface, with at least one antenna element formed on the lower surface;
at least one semiconductor component forming part of a beamforming network, BFN, having a lower surface attached to the upper surface of the antenna substrate, wherein the lower surface of the at least one semiconductor component is radio frequency, RF, coupled to the at least one antenna element through the antenna substrate, and the at least one semiconductor component is electrically connected to other components of the BFN through an upper surface of the at least one semiconductor component; and
first molding material formed on the upper surface of the antenna substrate and at least partially encapsulating the at least one semiconductor component; and
second molding material adhering the plurality of subassemblies to one another, the second molding material having an upper surface that is coplanar with an upper surface of the first molding material.

2. The antenna apparatus of claim 1, wherein the plurality of subassemblies are cooperatively coupled to one another to form an electronically steerable antenna array.

3. The antenna apparatus of claim 1, wherein:
the second molding material includes a lower portion and a further portion directly above the lower portion; and
each antenna substrate includes a side surface adhered to a side surface of an adjacent antenna substrate by the lower portion of the second molding material.

4. The antenna apparatus of claim 1, wherein the attachment of the lower surface of the at least one semiconductor component to the upper surface of the antenna substrate is made through metal pillars, formed on the lower surface of the at least one semiconductor component or the upper surface of the antenna substrate, and solder on the metal pillars.

5. The antenna apparatus of claim 1, wherein in each of the subassemblies, the RF coupling of the at least one semiconductor component to the antenna elements is made through at least one via within the antenna substrate.

6. The antenna apparatus of claim 1, wherein each of the subassemblies includes a plurality of electrical contacts of a redistribution layer, RDL, formed on an upper surface of the first molding material.

7. The antenna apparatus of claim 6, further comprising a printed wiring board, PWB, that provides a control signal and/or a bias voltage to the at least one semiconductor component of each of the plurality of subassemblies through the RDL and a solder bump connecting the RDL and an electrical contact of the PWB.

8. The antenna apparatus of claim 7, wherein the RDL includes fan out conductive traces that fan out from each of the at least one semiconductor component.

9. The antenna apparatus of claim 1, further comprising a combiner/divider having at least a portion thereof disposed between first and second ones of the plurality of subassemblies adjacent to one another.

10. An antenna apparatus comprising:
a plurality of subassemblies each comprising:
an antenna substrate having an upper surface and a lower surface, with at least one antenna element formed on the lower surface;
at least one semiconductor component forming part of a beamforming network, and having a lower surface attached to the upper surface of the antenna substrate, wherein the at least one semiconductor component is radio frequency, RF, coupled to the at least one antenna element through the antenna substrate; and
first molding material formed on the upper surface of the antenna substrate and at least partially encapsulating the at least one semiconductor component;
second molding material adhering the plurality of subassemblies to one another; and
a combiner/divider having at least a portion thereof disposed between first and second ones of the plurality of subassemblies adjacent to one another the combiner/divider including a dielectric substrate that is at least partially encapsulated by the second molding material.

11. The antenna apparatus of claim 10, wherein:
a first antenna substrate of the first one of the plurality of subassemblies has an upper surface having a first peripheral portion;
a second antenna substrate of the second one of the plurality of subassemblies adjacent the first one of the plurality of subassemblies has an upper surface having a second peripheral portion; and
the combiner/divider has a lower surface comprising first and second surface regions adjacent to one another, the first surface region being adhered to the first peripheral portion and the second surface region being adhered to the second peripheral portion, and the combiner/divider being at least partially encapsulated on side surfaces thereof by the second molding material.

12. An antenna apparatus comprising:
a plurality of subassemblies each comprising:
an antenna substrate having an upper surface and a lower surface, with at least one antenna element formed on the lower surface;
at least one semiconductor component forming part of a beamforming network, and having a lower surface attached to the upper surface of the antenna substrate, wherein the at least one semiconductor component is radio frequency, RF, coupled to the at least one antenna element through the antenna substrate; and
first molding material formed on the upper surface of the antenna substrate and at least partially encapsulating the at least one semiconductor component;
second molding material adhering the plurality of subassemblies to one another; and
a combiner/divider having at least a portion thereof disposed between first and second ones of the plurality of subassemblies adjacent to one another, the combiner/divider comprising a substrate composed of the second molding material, and conductive traces of a redistribution layer on an upper surface of the second molding material.

13. The antenna apparatus of claim 1, wherein each of the subassemblies further includes at least one integrated circuit, IC, chip for digital beamforming, adhered to the antenna substrate thereof and RF coupled to the at least one semiconductor component.

14. The antenna apparatus of claim 13, wherein the at least one IC chip includes at least one of an analog to digital converter (ADC) or a digital to analog converter (DAC) coupled to the at least one semiconductor component.

15. The antenna apparatus of claim 13, wherein the at least one IC chip includes at least one of: (i) a downconverter to downconvert signals received from the at least one semiconductor component in a receive path; and (ii) an upconverter to upconvert signals provided to the at least one semiconductor component in a transmit path.

16. The antenna apparatus of claim 1, wherein:
each said antenna substrate further includes a ground plane proximate to or forming a part of the upper surface thereof; and
the ground plane of a first antenna substrate of a first subassembly of the subassemblies is at least partially separated from the ground plane of a second antenna substrate of a second subassembly of the subassemblies adjacent to the first subassembly.

17. The antenna apparatus of claim 1, wherein:
each said antenna substrate further includes a ground plane proximate to or forming a part of the upper surface thereof; and
a first ground plane of a first antenna substrate of a first subassembly of the subassemblies is electrically connected to a second ground plane of a second antenna substrate of a second subassembly of the subassemblies adjacent to the first subassembly.

18. The antenna apparatus of claim 17, further comprising a combiner/divider including at least a portion between the first and second subassemblies, wherein the first ground plane is electrically connected to the second ground plane by conductive epoxy that adheres the combiner/divider to each of a first portion of the first ground plane and a second portion of the second ground plane.

19. The antenna apparatus of claim 1, wherein the first molding material and the second molding material are composed of a same type of material.

20. The antenna apparatus of claim 1, wherein the first molding material is a different type of material than the second molding material.

21. The antenna apparatus of any of claim 1, wherein the at least one semiconductor component includes at least one amplifier chip.

22. The antenna apparatus of claim 21, wherein:
the first molding material is disposed on side surfaces of the at least one amplifier chip and on peripheral portions of the upper surface of the at least one amplifier chip;
a central portion of the upper surface of the at least one amplifier chip interfaces with air; and
the at least one amplifier chip includes an active circuit region directly behind the upper surface thereof.

23. The antenna apparatus of claim 1, wherein the at least one semiconductor component includes at least one phase shifter chip.

24-30. (canceled)
